(19) United States
(12) Patent Application Publication
(10) Pub. No.: US 2025/0164675 A1
(43) Pub. Date: May 22, 2025

(54) REFLECTIVE STRUCTURES

(71) Applicant: 3M INNOVATIVE PROPERTIES COMPANY, St. Paul, MN (US)

(72) Inventors: Susannah C. Clear, Hastings, MN (US); Travis L. Potts, Woodbury, MN (US); Jincy Jose, Eagan, MN (US); Kenneth L. Smith, White Bear Lake, MN (US); John M. DeSutter, Maplewood, MN (US)

(21) Appl. No.: 18/839,542

(22) PCT Filed: Feb. 27, 2023
(86) PCT No.: PCT/IB2023/051826

§ 371 Date: Aug. 19, 2024

Related U.S. Application Data
(60) Provisional application No. 63/314,548, filed on Feb. 28, 2022.

(51) Int. Cl. G02B 5/136; E01F 9/524; G02B 1/04

(52) U.S. Cl. CPC G02B 5/136; G02B 1/04; E01F 9/524

(57) ABSTRACT

The present disclosure is directed to reflective microstructures where at least part of the reflective surface of the microstructure is radially symmetric around a given axis. The disclosure is also directed to articles comprising the reflective microstructures.

The present disclosure is directed to reflective structures where at least part of the reflective surface of the structure is radially symmetric around a given axis. The disclosure is also directed to articles comprising the reflective structures.

### BACKGROUND

Vulnerable road users (“VRUs,” e.g., pedestrians or cyclists) put themselves at risk any time they are crossing, sharing, or moving adjacent to a roadway where motor vehicles are operating. Cities and state transportation agencies have placed increased emphasis on safety of VRUs, particularly at intersections, especially with the advent of new shared transportation and micromobility solutions and the trend toward increased urbanization.

Cities have implemented various passive and active solutions, which have a wide range of costs. Passive options include replacing conventional pavement markings in crosswalks with crosswalks comprising large continental blocks with or without rails, signage mounted on the crosswalk, and installation of pedestrian refuge islands. Active solutions include externally lit crosswalks (automatic or manually-activated) and beacons (e.g. high-intensity activated crosswalk (HAWK) beacon, rectangular rapid flash beacons), and pedestrian signals synchronized with traffic lights. Among the solutions placed on the surface of the roadway, embedded lights on a crosswalk have proven particularly effective, but generally have a cost that about 60 times the cost of traditional crosswalk pavement markings.

Traditional pavement markings are based on diffuse light reflectance (e.g. white paint) or on retroreflective optics, where the reflective surface is concave (e.g. cat's eye, bead) or indented (e.g. cube-corner reflector). In general, a retroreflector is designed so that the returned ray has very little divergence and is directed back at the light source.

The reflective articles of this disclosure fit in the space between passive crosswalks and in-road crosswalk lights, providing one or more regions of better light return than retroreflective or diffusely reflecting markings without the expense and damage of installation of an active in-road crosswalk light.

### SUMMARY

This disclosure describes reflective articles comprising an array of one or more reflective structures distributed on a substantially planar surface where the structures
have a portion that is radially symmetric around an axis normal to the planar surface,
comprise a first reflective surface that is at least 50% specular,
where the specular surface exhibits convex curvature in at least one coordinate,
where this convex curved surface reflects incident light in a divergent pattern in at least one coordinate dimension.

In other embodiments, this disclosure is directed to pavement markings comprising reflective articles.

The reflective articles differ from traditional pavement markings that are based on retroreflective optics, where the light is reflected towards the light source, because the present reflective articles are based on reflective surfaces that are convex in at least one coordinate. In conventional retroreflective pavement marking designs, the retroreflector is designed so that the returned ray has very little divergence. At least in part, the reflective articles of this disclosure rely on divergent reflected rays to produce a visible light return.

In some embodiments of this invention, arrays of these reflective features would be deployed in, on or near the ground. Examples include pavement markings on a roadway surface, or markings on a slightly elevated surface such as a raised pavement markers or pedestrian islands.

In one general embodiment, a reflective article comprises:
a substrate having a structured surface that extends along a reference plane, wherein the structured surface comprises at least one opaque structure,
wherein the at least one structure comprises a reflective surface configured to reflect radiation rays,
wherein the reflected rays comprise either diverging rays or converging rays,
wherein at least part of the reflective surface is radially symmetric around an axis that is normal to the reference plane, and
wherein the reflective surface is the outer surface of the structure.

All scientific and technical terms used herein have meanings commonly used in the art unless otherwise specified. The definitions provided herein are to facilitate understanding of certain terms used frequently in this application and are not meant to exclude a reasonable interpretation of those terms in the context of the present disclosure.

Unless otherwise indicated, all numbers in the description and the claims expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g. a range from 1 to 5 includes, for instance, 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The term “adjacent” refers to the relative position of two elements, such as, for example, two layers, that are close to each other and may or may not be necessarily in contact with each other or that may have one or more layers separating the two elements as understood by the context in which “adjacent” appears.

The term “immediately adjacent” refers to the relative position of two elements, such as, for example, two layers, that are next to each other and in contact with each other and have no intermediate layers separating the two elements. The term “immediately adjacent,” however, encompasses situations where one or both elements (e.g., layers) have been treated with a primer, or whose surface has been modified to affect the properties thereof, such as etching, embossing, etc., or has been modified by surface treatments, such as corona or plasma treatment, etc. that may improve adhesion.

The term “structure” refers to a geometric protrusion on a surface, where the surface is coplanar with a reference plane. A geometric protrusion refers to a protrusion that comprises: a) a full or partial 3-dimensional geometric shape or b) a shape that is the combination of two or more full or partial 3-dimensional geometric shapes.

The term “structured surface” refers to a surface, or portion of a surface, having a plurality of structures in a repeating pattern.

The term “reflective surface” refers to a surface that reflects electromagnetic radiation (rays).

The term “retroreflective surface” refers to a surface that reflects incoming electromagnetic radiation in the direction of the source of radiation.

The term “Electromagnetic radiation” in this context includes, but is not limited to, visible light (400 nm-700 nm), near infrared radiation (700 nm-2000 nm, preferably 800 nm-1600 nm), radar radiation (3.7 mm-12 mm), and ultraviolet radiation (300 nm-400 nm).

A surface with specular reflection occurs when radiation is reflected from a surface at an angle which is equal to the angle of incidence but opposite in sign when measured relative to the normal vector for the surface. In this patent application, a surface with specular reflection does not encompass a retroreflective surface, even if a small fraction of incident rays may be reflected in the direction of the source of radiation.

A surface is “radially symmetric” around an axis that is normal to a reference plane if the surface inscribes a circle (or a portion of a circle) with constant radius on a plane that is parallel to the reference plane. For instance, a sphere is radially symmetric around an axis that passes through both poles of the sphere.

A variable having a constant value in this application refers to a value that ranges ±10% around an average value. For example, a circle with a constant radius of 5 units represents a circle where any point on the circle is at a distance of 5 (5*0.1) units from the center of the circle. By analogy, a variable that is not constant refers to a variable where one or more of its values are outside of the range defined by the arithmetic average value ±10%.

An opaque surface refers to a surface that transmits less than 2% of electromagnetic radiation from one side of the layer to the other. A clear layer allows transmission of 90% or more electromagnetic radiation from one side of the surface to the other.

An outer surface of a structure refers to the outermost surface of the structure, which in most embodiments is the reflective surface. A clear layer on a structure is not the outer surface of the structure. The clear layer may be a thin conforming layer that follows the contour of the structure or it may be a thicker coating that encapsulates the structure and has a flat surface.

A convex reflective surface or diverging surface is a curved surface in which the reflective surface bulges towards the light source. That is, convex reflective surfaces reflect light outwards and, therefore, they do not focus light.

A concave reflective surface, or converging surface, has a reflecting surface that is recessed inward (away from the incident light). That is, concave reflective surfaces reflect light inward to one focal point, therefore, can be used to focus light.

It is important to note that the same structure may have both concave and convex reflective surfaces, depending on the plane on which the surface resides. See, for example, FIG. 8, which shows the convex and concave portions of a given structure (second structure from the right).

A flat surface is a surface in which any point within the surface lies substantially on the same plane as any other point on the surface. For instance, if a given structure has a flat surface, then all points on that surface are located on the same plane (reference plane) or at a distance from the reference plane that is 10% of less of the structure's characteristic dimension. The characteristic dimension of a structure is the longest dimension from among the height, width (or radius as the case may be), or depth.

A straight line between point A and B is a line in which any point within the line lies substantially within shortest line that passes through points A and B (“shortest line.”) For instance, if a given structure has a straight line, then all points on that line are located on the shortest line or at a distance from the shortest line that is 5% or less of the structure's characteristic dimension.

A line A is parallel to line B if all points on line A are at distance from the corresponding point in line B that is within 5% of the average distance between lines A and B. A point in line B corresponds to a point in line A if they are both on a line that is orthogonal to line A. The average distance between lines A and B is the arithmetic average of the distance between points in line A and their corresponding points in line B.

A plane A is parallel to plane B if all points on plane A are at distance from the corresponding point in plane B that is within 5% of the average distance between planes A and B. A point in plane B corresponds to a point in plane A if they are both on a line that is orthogonal to plane A. The average distance between planes A and B is the arithmetic average of the distance between points in plane A and their corresponding points in plane B.

In situations where a structure is a composite structure comprising at least two portions, and each portion has a curve formed by the intersection of a plane orthogonal to the reference plane and the portion of the reflective surface that is radially symmetric, and the curve from one portion is different from the curve of the other portion when the absolute difference of the average distance from points in curve 1 to the origin minus the average distance from points in curve 2 to origin are greater than 5 percent of the average distance from points in curve 1 to origin.

### BRIEF DESCRIPTION OF THE DRAWINGS

FIG. 1 shows an exemplary reflective article of the present disclosure showing hotspots of visible light.

FIG. 2 shows an exemplary situation where reflective structures of the present disclosure can be employed.

FIG. 3 is a schematic representation of the scenario in FIG. 2, including a sample reflective structure.

FIG. 4 SolidWorks drawing. Clockwise from front: 1) quarterspheres, 2) hemispheres, 3) Concave Structures, and 4) Beehives.

FIG. 5 shows (A) a cross-section of a structure in the simulation and the packing configuration and (B) shows a polar plot that illustrates the projected area map of the far-field hemispherical reflected light return.

FIG. 6 shows the dimensions of a cone array used in the simulation.

FIG. 7 illustrates incident and reflected rays from specific locations in the illuminated quadrant for an overlapping hexagonal array of cones.

FIG. 8 Shows examples of convex, concave, and other types of curvature in the examples.

### DETAILED DESCRIPTION

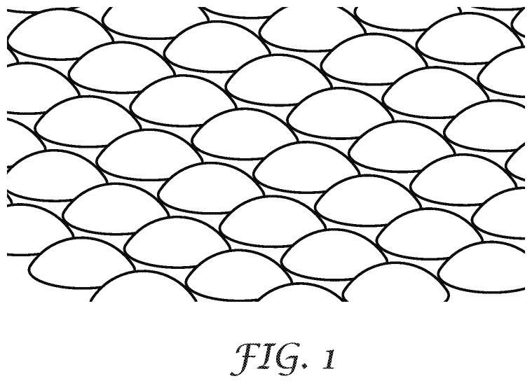

As mentioned previously, the reflective structures of this disclosure are not considered retroreflective structures because they are not designed to reflect light (or any other type of electromagnetic radiation) to the energy source. In contrast, the reflective structures create a “hotspot” of light visible over a range of angles even when the observation angle between the light source and the observer is not small. These hotspots are illustrated in FIG. 1, shown as the white spot having a generally circular shape on the surface of the structures.

The present reflective structures differ from diffusely reflecting surfaces (e.g. white paint) because they generate hotspots with a higher density of reflected rays (or luminance) at the observer than a diffusely reflecting surface. In these hot spots, it is possible to generate hot spots with luminance values with these reflectors that are at least an order of magnitude higher than that produced by a >99% diffuse reflecting surface, based on the feature geometries and radii of curvature exemplified in this disclosure.

In general, a retroreflector is designed so that the returned ray has very little divergence. In contrast, the present reflective structures rely, at least in part, on divergent reflected rays to produce a visible light return.

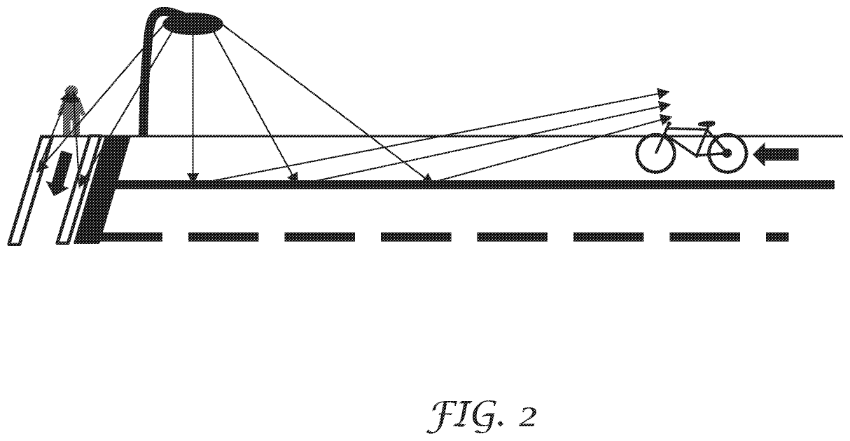

FIG. 2 illustrates geometries of illumination and observation for an exemplary scenario where reflective structures of this disclosure, shown being part of a pavement marking, can be employed. Light sources are considered as 180 degree Lambertian sources. In real-life situations, streetlamp(s) may be centered above the roadway, above the right-hand turn lane, or on the curb.

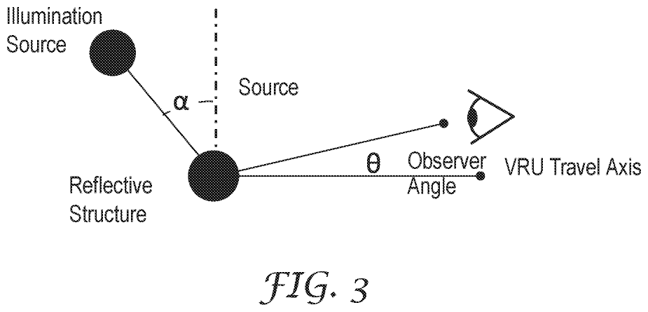

They may also be positioned at a range of heights above the roadway surface. To cover this range of potential options, the light source is assumed to be positioned at an incident angle (a) between zero and 40 degrees from the normal to the planar surface. The position of the light source also can vary azimuthally, depending on where streetlamp(s) are positioned on a curb relative to a crosswalk. Thus, the light source is assumed to be at any azimuthal angle (source) around the normal. FIG. 3 is a schematic representation of the scenario in FIG. 2, including a sample reflective structure.

In general, the reflective structures redirect a useful fraction of incident rays in some or all azimuthal directions (ϕ_{observer}) to observers at minimum elevation angles (θ) less than or equal to 17.5 degrees as “hotspots” from each reflective feature (as shown in FIG. 1). This range of minimum elevation angles is selected to cover useful observer maximum detection distances relative to the reflective article as the observer approaches the reflective article, as in the use cases of a cyclist approaching a marking or a pedestrian viewing a crosswalk as illustrated in FIG. 2.

The redirected rays from these hotspots are divergent, but a sufficiently large number per unit area reach the observer because hotspots have a luminance substantially brighter than that of the surrounding roadway substrate and are also brighter than that of a perfect diffuse reflecting flat surface. These hotspots provide an increased contrast ratio relative to the roadway substrate, improving the likelihood of visual detection of the reflective feature.

The following embodiments exemplify, without limiting, reflective structures that can be useful to highlight pavement marking articles containing them to VRUs.

### General Structures

In some embodiments, the reflective article comprises:
a substrate having a structured surface that extends along a reference plane, wherein the structured surface comprises at least one opaque structure,
wherein the at least one structure comprises:
   a reflective surface configured to reflect radiation rays,
   wherein the reflected rays comprise either diverging rays or converging rays,
   wherein at least part of the reflective surface is radially symmetric around an axis that is normal to the reference plane, and
   wherein the reflective surface is the outer surface of the structure.

### Convex Structures in General (e.g., Beehive, Hemispheres)

In some embodiments, the reflective article comprises:
a substrate having a structured surface that extends along a reference plane, wherein the structured surface comprises at least one opaque structure,
wherein the at least one structure comprises:
   a reflective surface configured to reflect radiation rays,
   wherein the reflected rays comprise either diverging rays or converging rays,
   wherein at least part of the reflective surface is radially symmetric around an axis that is normal to the reference plane,
wherein the reflective surface is the outer surface of the structure,
   wherein at least part of the radially symmetric reflective surface is convex along the curve formed by the intersection of a plane orthogonal to the reference plane and the portion of the surface that is radially symmetric.

### Hemispheres

In some embodiments, the reflective article comprises:
a substrate having a structured surface that extends along a reference plane, wherein the structured surface comprises at least one opaque structure,
wherein the at least one structure comprises:
   a reflective surface configured to reflect radiation rays,
   wherein the reflected rays comprise diverging rays,
   wherein at least part of the reflective surface is radially symmetric around an axis that is normal to the reference plane,
   wherein the reflective surface is the outer surface of the structure,
      wherein at least part of the radially symmetric reflective surface is convex along the curve formed by the intersection of a plane orthogonal to the reference plane and the portion of the surface that is radially symmetric and has a given radius of curvature,
      wherein the radius of curvature is constant measured from an origin to any point on the curve formed by the intersection of a plane orthogonal to the reference plane and the portion of the convex surface that is radially symmetric,
   wherein the origin is at the intersection of the axis around which the reflective surface is radially symmetric (axis of symmetry) and the reference plane.

### Beehives

In some embodiments, the reflective article comprises:
a substrate having a structured surface that extends along a reference plane, wherein the structured surface comprises at least one opaque structure,
wherein the at least one structure comprises:
   a reflective surface configured to reflect radiation rays,
   wherein the reflected rays comprise diverging rays,
   wherein at least part of the reflective surface is radially symmetric around an axis that is normal to the reference plane,
   wherein the reflective surface is the outer surface of the structure,
   wherein at least part of the radially symmetric reflective surface is convex along the curve formed by the intersection of a plane orthogonal to the reference plane and the portion of the surface that is radially symmetric and has a given radius of curvature,
   wherein the radius of curvature is non-constant when measured from an origin to points on the curve formed by the intersection of a plane orthogonal to the reference plane and the portion of the convex surface that is radially symmetric,
   wherein the origin is at the intersection of the axis around which the reflective surface is radially symmetric and the reference plane.

### Concave Structures in General

In some embodiments, the reflective article comprises:
a substrate having a structured surface that extends along a reference plane, wherein the structured surface comprises at least one opaque structure,
wherein the at least one structure comprises:
   a reflective surface configured to reflect radiation rays,
   wherein the reflected rays are diverging or converging,
   wherein at least part of the reflective surface is radially symmetric around an axis that is normal to the reference plane,
   wherein the structure is opaque,
   wherein the reflective surface is the outer surface of the structure,
   wherein at least part of the radially symmetric reflective surface is concave along the curve formed by the intersection of a plane orthogonal to the reference plane and the portion of the surface that is radially symmetric.

### Cone Structure

In some embodiments, the reflective article comprises:
a substrate having a structured surface that extends along a reference plane, wherein the structured surface comprises at least one opaque structure,
wherein the at least one structure comprises:
   a reflective surface configured to reflect radiation rays,
   wherein the reflected rays are diverging,
   wherein at least part of the reflective surface is radially symmetric around an axis that is normal to the reference plane,
   wherein the structure is opaque,
   wherein the reflective surface is the outer surface of the structure,
   wherein at least part of the radially symmetric reflective surface is a straight line along the intersection of a plane orthogonal to the reference plane and the portion of the surface that is radially symmetric, wherein one edge on the straight line overlaps with the axis that is normal to the reference plane.

### Arrays

In some embodiments, the reflective article comprises:
a substrate having a structured surface that extends along a reference plane, wherein the structured surface comprises a plurality of opaque structures,
wherein the structures comprises:
   a reflective surface configured to reflect radiation rays,
   wherein the reflected rays comprise either diverging rays or converging rays,
   wherein at least part of the reflective surface is radially symmetric around an axis that is normal to the reference plane, and
   wherein the reflective surface is the outer surface of the structure,
   wherein the plurality of opaque structures are arranged in a repeating pattern.

Additional exemplary embodiments will be described below.

### Exemplary Embodiments

1. A reflective article comprising:
   a substrate having a structured surface that extends along a reference plane, wherein the structured surface comprises at least one opaque structure,
   wherein the at least one structure comprises:
   a reflective surface configured to reflect radiation rays,
   wherein the reflected rays comprise either diverging rays or converging rays,
   wherein at least part of the reflective surface is radially symmetric around an axis that is normal to the reference plane, and
   wherein the reflective surface is the outer surface of the structure.
2. A reflective article comprising:
   a substrate having a structured surface that extends along a reference plane, wherein the structured surface comprises at least one opaque structure,
   wherein the at least one structure comprises:
   a reflective surface configured to reflect radiation rays,
   wherein the reflected rays comprise either diverging rays or converging rays,
   wherein at least part of the reflective surface is radially symmetric around an axis that is normal to the reference plane,
   wherein the reflective surface is the outer surface of the structure,
   wherein at least part of the radially symmetric reflective surface is convex along the curve formed by the intersection of a plane orthogonal to the reference plane and the portion of the surface that is radially symmetric.
3. A reflective article comprising:
   a substrate having a structured surface that extends along a reference plane,
   wherein the structured surface comprises at least one opaque structure, wherein the at least one structure comprises:
   a reflective surface configured to reflect radiation rays,
   wherein the reflected rays comprise diverging rays,
   wherein at least part of the reflective surface is radially symmetric around an axis that is normal to the reference plane,
   wherein the reflective surface is the outer surface of the structure,
   wherein at least part of the radially symmetric reflective surface is convex along the curve formed by the intersection of a plane orthogonal to the reference plane and the portion of the surface that is radially symmetric and has a given radius of curvature,
   wherein the radius of curvature is constant measured from an origin to any point on the curve formed by the intersection of a plane orthogonal to the reference plane and the portion of the convex surface that is radially symmetric,
   wherein the origin is at the intersection of the axis around which the reflective surface is radially symmetric (axis of symmetry) and the reference plane.
4. A reflective article comprising:
   a substrate having a structured surface that extends along a reference plane, wherein the structured surface comprises at least one opaque structure,
   wherein the at least one structure comprises:
   a reflective surface configured to reflect radiation rays,
   wherein the reflected rays comprise diverging rays,
   wherein at least part of the reflective surface is radially symmetric around an axis that is normal to the reference plane,
   wherein the reflective surface is the outer surface of the structure,
   wherein at least part of the radially symmetric reflective surface is convex along the curve formed by the intersection of a plane orthogonal to the reference plane and the portion of the surface that is radially symmetric and has a given radius of curvature, wherein the radius of curvature is non-constant when measured from an origin to points on the curve formed by the intersection of a plane orthogonal to the reference plane and the portion of the convex surface that is radially symmetric,
   wherein the origin is at the intersection of the axis around which the reflective surface is radially symmetric and the reference plane.
5. A reflective article comprising:
   a substrate having a structured surface that extends along a reference plane, wherein the structured surface comprises at least one opaque structure,
   wherein the at least one structure comprises:
   a reflective surface configured to reflect radiation rays,
   wherein the reflected rays are diverging or converging,
   wherein at least part of the reflective surface is radially symmetric around an axis that is normal to the reference plane,
   wherein the structure is opaque,
   wherein the reflective surface is the outer surface of the structure,
   wherein at least part of the radially symmetric reflective surface is concave along the curve formed by the intersection of a plane orthogonal to the reference plane and the portion of the surface that is radially symmetric.
6. A reflective article comprising:
   a substrate having a structured surface that extends along a reference plane, wherein the structured surface comprises at least one opaque structure,
   wherein the at least one structure comprises:
   a reflective surface configured to reflect radiation rays,
   wherein the reflected rays are diverging,
   wherein at least part of the reflective surface is radially symmetric around an axis that is normal to the reference plane,
   wherein the structure is opaque,
   wherein the reflective surface is the outer surface of the structure,
   wherein at least part of the radially symmetric reflective surface is a straight line along the intersection of a plane orthogonal to the reference plane and the portion of the surface that is radially symmetric,
   wherein one edge on the straight line overlaps with the axis that is normal to the reference plane.
7. A reflective article comprising:
   a substrate having a structured surface that extends along a reference plane, wherein the structured surface comprises a plurality of opaque structures,
   wherein the structures comprise:
   a reflective surface configured to reflect radiation rays,
   wherein the reflected rays comprise either diverging rays or converging rays,
   wherein at least part of the reflective surface is radially symmetric around an axis that is normal to the reference plane, and
   wherein the reflective surface is the outer surface of the structure,
   wherein the plurality of opaque structures are arranged in a repeating pattern.
8. A reflective article comprising:
   a substrate having a structured surface that extends along a reference plane, wherein the structured surface comprises a plurality of opaque structures,
   wherein the structures comprise:
   a reflective surface configured to reflect radiation rays,
   wherein the reflected rays comprise either diverging rays or converging rays,
   wherein at least part of the reflective surface is radially symmetric around an axis that is normal to the reference plane, and
   wherein the reflective surface is the outer surface of the structure,
   wherein the plurality of opaque structures are arranged in a repeating pattern,
   wherein the plurality of opaque structures are chosen from the structures described in any of the embodiments 1-7 above.
9. A reflective article according to any of the preceding embodiments, wherein the structured surface comprises a plurality of opaque structures arranged in a repeating pattern,
   wherein the pattern is a hexagon having a structure with its axis of symmetry located on each vertex of the hexagon and at the centroid of the hexagon.
10. A reflective article according to any of the preceding embodiments, wherein the structured surface comprises a plurality of opaque structures arranged in a repeating pattern, wherein the pattern is a square having a structure with its axis of symmetry located on each vertex of the square and optionally at the centroid of the square
11. A reflective article according to any of the preceding embodiments, wherein the structured surface comprises a plurality of opaque structures arranged in a repeating pattern, wherein the pattern is a hexagon having a structure with its axis of symmetry located on each vertex of the hexagon and at the centroid of the hexagon, and wherein at least two structures are touching each other.
12. A reflective article according to any of the preceding embodiments, wherein the structured surface comprises a plurality of opaque structures arranged in a repeating pattern, wherein the pattern is a hexagon having a structure with its axis of symmetry located on each vertex of the hexagon and at the centroid of the hexagon, and wherein the structures in at least one hexagon are not touching each other.
13. A reflective article according to any of the preceding embodiments, wherein the structured surface comprises a plurality of opaque structures arranged in a repeating pattern, wherein the pattern is a square having a structure with its axis of symmetry located on each vertex of the square and optionally at the centroid of the square, and wherein at least two structures are touching each other.
14. A reflective article according to any of the preceding embodiments, wherein the structured surface comprises a plurality of opaque structures arranged in a repeating pattern, wherein the pattern is a square having a structure with its axis of symmetry located on each vertex of the square and optionally at the centroid of the square, and wherein the structures in at least one square are not touching each other.
15. A reflective article according to any of the preceding embodiments, wherein the reflective surface reflects from 50% to 100% of the incident rays in a specular manner.
16. A reflective article according to any of the preceding embodiments, wherein the reflective surface reflects from 50% to 100% of the incident rays in a specular manner in one or more of the following ranges: near infrared, visible, and ultraviolet spectra.
17. A reflective article according to any of the preceding embodiments, wherein the reflective surface reflects from 75% to 100% of the incident rays in a specular manner in one or more of the following ranges: near infrared, visible, and ultraviolet spectra.
18. A reflective article according to any of the preceding embodiments, wherein the reflective surface reflects from 90% to 100% of the incident rays in a specular manner in one or more of the following ranges: near infrared, visible, and ultraviolet spectra.
19. A reflective article according to any of the preceding embodiments, wherein the reflective surface reflects from 50% to 100% of the incident rays in a specular manner in the visible spectrum.
20. A reflective article according to any of the preceding embodiments, wherein the reflective surface reflects from 60% to 100% of the incident rays in a specular manner in the visible spectrum.
21. A reflective article according to any of the preceding embodiments, wherein the reflective surface reflects from 70% to 100% of the incident rays in a specular manner in the visible spectrum.
22. A reflective article according to any of the preceding embodiments, wherein the reflective surface reflects from 80% to 100% of the incident rays in a specular manner in the visible spectrum.
23. A reflective article according to any of the preceding embodiments, wherein the reflective surface reflects from 85% to 100% of the incident rays in a specular manner in the visible spectrum.
24. A reflective article according to any of the preceding embodiments, wherein the reflective surface reflects from 90% to 100% of the incident rays in a specular manner in the visible spectrum.
25. A reflective article according to any of the preceding embodiments, wherein the reflective surface reflects from 95% to 100% of the incident rays in a specular manner in the visible spectrum.
26. A reflective article according to any of the preceding embodiments, wherein the substrate comprises one or more polymers chosen from acrylic polymers, polycarbonate polymers, and polyurethane polymers.
27. A reflective article according to any of the preceding embodiments, wherein the reflective surface comprises one or more materials chosen from aluminum, silver, dichroic film, and combinations thereof.
28. A reflective article according to any of the preceding embodiments, wherein the reflective surface is a coating immediately adjacent to the substrate forming the structure.
29. A reflective article according to any of the preceding embodiments, wherein the reflective surface is a layer immediately adjacent to the substrate forming the structure.
30. A reflective article according to any of the preceding embodiments, wherein the reflective layer comprises thermoformed multilayer optical film.
31. A reflective article according to any of the preceding embodiments, wherein the substrate comprises microreplicated structures.
32. A reflective article according to any of the preceding embodiments, wherein the top portion of at least one structure is a flat surface parallel to the reference plane.
33. A reflective article according to any of the preceding embodiments, further comprising a land layer immediately adjacent to the substrate.
34. A reflective article according to any of the preceding embodiments, further comprising a land layer immediately adjacent to the substrate, and wherein the land is an extruded layer.
35. A reflective article according to any of the preceding embodiments, further comprising a land layer immediately adjacent to the substrate, and wherein the land layer is made of the same material as the substrate.
36. A reflective article according to any of the preceding embodiments, further comprising a land layer immediately adjacent to the substrate, and wherein the land layer is made of a material different from the material of the substrate.
37. A reflective article according to any of the preceding embodiments, wherein each structure has a height and a radius,
   wherein the height is defined by the distance from the reference plane to the point where the axis of symmetry intersects the radially symmetric surface, and
   wherein the radius is defined by the average distance from an origin to the line formed by the intersection of the reference plane with the portion of the structure that is radially symmetric,
   wherein the origin is at the intersection of the axis of symmetry and the reference plane,
   wherein the height ranges from 50 microns to 7 mm.
38. A reflective article according to any of the preceding embodiments, wherein each structure has a height and a radius,
   wherein the height is defined by the distance from the reference plane to the point where the axis of symmetry intersects the radially symmetric surface, and
   wherein the radius is defined by the average distance from an origin to the line formed by the intersection of the reference plane with the portion of the structure that is radially symmetric,
   wherein the origin is at the intersection of the axis of symmetry and the reference plane, wherein the height ranges from 50 microns to 200 microns.
39. A reflective article according to any of the preceding embodiments, wherein each structure has a height and a radius,
   wherein the height is defined by the distance from the reference plane to the point where the axis of symmetry intersects the radially symmetric surface, and
   wherein the radius is defined by the average distance from an origin to the line formed by the intersection of the reference plane with the portion of the structure that is radially symmetric,
   wherein the origin is at the intersection of the axis of symmetry and the reference plane, wherein the height ranges from 100 microns to 200 microns.
40. A reflective article according to any of the preceding embodiments, wherein at least one structure is a composite structure comprising at least two portions,
   wherein each portion has a curve formed by the intersection of a plane orthogonal to the reference plane and the portion of the reflective surface that is radially symmetric, and
   wherein the curve from one portion is different from the curve of the other portion,
   wherein the origin is at the intersection of the symmetry axis and the reference plane.
41. A reflective article according to any of the preceding embodiments, wherein in at least one structure the reflective surface does not extend throughout the entire surface of the structure.
42. A reflective article according to any of the preceding embodiments, wherein in at least one structure the reflective surface does not extend throughout the entire portion of the surface of the structure that is radially symmetric.
43. A reflective article according to any of the preceding embodiments, wherein in at least one structure the reflective surface does not extend throughout the entire surface of the structure, and wherein the portion of the structure not having a reflective surface has a matte surface.
44. A reflective article according to any of the preceding embodiments, wherein in at least one structure the reflective surface does not extend throughout the entire surface of the structure, and wherein the portion of the structure not having a reflective surface has a mate surface and is colored.
45. A reflective article according to any of the preceding embodiments, wherein the reflective surface covers 100% of the entire surface of the structure.
46. A reflective article according to any of the preceding embodiments, wherein in at least one structure the reflective surface extends from 10% to 80% of the entire surface of the structure.
47. A reflective article according to any of the preceding embodiments, wherein in at least one structure the reflective surface extends from 10% to 750% of the entire surface of the structure.
48. A reflective article according to any of the preceding embodiments, wherein in at least one structure the reflective surface extends from 10% to 60% of the entire surface of the structure.
49. A reflective article according to any of the preceding embodiments, wherein in at least one structure the reflective surface extends from 10% to 50% of the entire surface of the structure.
50. A reflective article according to any of the preceding embodiments, wherein in at least one structure the reflective surface extends from 10% to 40% of the entire surface of the structure.
51. A reflective article according to any of the preceding embodiments, wherein in at least one structure the reflective surface extends from 10% to 30% of the entire surface of the structure.
52. A reflective article according to any of the preceding embodiments, wherein in at least one structure the reflective surface extends from 10% to 250% of the entire surface of the structure.
53. A reflective article according to any of the preceding embodiments, wherein at least one structure is encapsulated in a clear layer.
54. A reflective article according to any of the preceding embodiments, wherein at least one structure further comprises a clear layer.
55. A reflective article according to any of the preceding embodiments, wherein at least one structure further comprises a clear layer, and wherein the clear layer comprises one of more of crosslinked acrylic, crosslinked urethane acrylic, fluoropolymer, fluoro-acrylate, and silicone polymers.
56. A reflective article according to any of the preceding embodiments, wherein the structured surface is encapsulated in a clear layer.
57. A reflective article according to any of the preceding embodiments, wherein the article further comprises an adhesive layer.
58. A system comprising a reflective article according to any of the preceding embodiments and a light source.

### Examples

### Example 1—Luminance Measurements of Physical Structures 3D Printed Construction of Structures

Physical samples including arrays of square packed structures were prepared by additive manufacturing and then an optically dense layer of silver, approximately 300 nm thick, was applied by chemical vapor deposition. Sample A represents an idealized painted pavement marking, a diffuse reflecting surface, and was a 254 mm square panel purchased from Spectralon (Spectralon Corporation, NY, USA). Table 1. describes the basic dimensions of the different structures, including a flat control structure, concave structures, beehive structures, hemispheres, and quarterspheres. The concave structure is additionally defined by a profile rotated about the y-axis of a 4^{th} order polynomial (y=−2.2284x⁴+3.5447x³−2.4913x²+0.0669x+1.2477) where the base diameter in the equation is 1 unit. The beehive structure is additionally defined by a profile rotated about the y-axis of a unitless 4^{th} order polynomial (y=2.2284x⁴−6.1501x³+6.7419x²−4.375x+1.5562) where the base diameter in the equation is 1 unit.

TABLE 1
Physical Sample Details

| | Height | Diameter | Packing | Center-to- Center |
|---|---|---|---|---|
| Sample | (mm) | (mm) | Structure | Distance (mm) |
| A | Flat | N/A | N/A | N/A |
| Concave Structures | 7.04 | 11.48 | Square | 13.0 |
| Beehives | 7.04 | 11.47 | Square | 13.0 |
| Hemispheres | 7.0 | 14 | Square | 15.0 |
| Quarterspheres | 3.5 | 12.12 | Square | 13.0 |

### Observer Illumination Test Method

Samples were centered on a rotating stage with gradations of 1 degree on an optical table, and the center of the sample was defined as the point where the surface normal intersected the plane of the substrate. The sample was 37.5 inches above the floor. The observer in these experiments was a Radiant Vision Systems Radiant ProMetric I-16 with a 200 mm e-lens. A 1.0 neutral density filter was used.

The Prometric was positioned on the centerline of the sample at a distance of 109.5 inches from the center of the sample and a height of 57 inches above the floor. This configuration defined an elevation angle for the observer (0) of 10 degrees. The real-time camera function of the software was used to finely align the sample to a plane defined by the ProMetric lens and the center of the sample by rotating it so that a row of the square packed structure was vertical in the image. This was defined as the zero-degree orientation of the sample and observer.

A diffuse light source OctaLux 5500K Daylight LED from Genaray (Gradus Group LLC), was used to illuminate the sample. All other light sources in the room were turned off The light source was mounted at a height of 55 inches above the plane of the sample for all configurations. Four configurations of light position relative to the plane defined by the fixturing of the ProMetric and sample were evaluated:
1. Light source directly overhead of the sample.
2. Light source, sample, and ProMetric all in the same plane with ProMetric on opposite side of sample as light source.
3. Two orthogonal planes that contain the lines of light source-sample and ProMetric-sample.
4. Light source, sample and ProMetric all in the same plane with ProMetric on same side of sample as light source.

In terms of the angles defined in FIG. 2, these cases have the following illumination and observation angles:

TABLE 2
Configuration Details

| | Illumination Incident Angle | Illumination Azimuthal |
|---|---|---|
| Configuration | (□) | Angle (□source ) |
| 1 | 0 | 0 |
| 2 | 40 | 0 |
| 3 | 40 | 90 |
| 4 | 40 | 180 |

Samples were measured at two angles to check the extremes of the effect of shadowing from the surface structure or array pattern on the results. The arrays of reflective structures were measured with the arrays oriented at either zero degrees or 22.5 degrees relative to the plane defined by the ProMetric and sample. The Spectralon material, being constructed of very fine scale expanded PTFE, is meant to be essentially optically isotropic, so was measured at orientations of zero and 90 degrees.

Average luminance and hotspot luminance were recorded for regions of the image in the vicinity of the focal plane of the image. Average luminance was recorded for regions that encompassed at least 10 features. Hotspot luminance was recorded for the maximum hotspot luminance observed in the focal plane. The maximum value was recorded because distortion due to focus effects results in light losses for distances smaller and greater than the focal distance. Typically, several reflective features in the focal plane exhibited luminance values approaching this maximum.

### Results

Results are reported in separate tables based on the source and observer configurations.

TABLE 3
Average and Hot Spot Luminance of
Physical Samples in Configuration 1

| Sample | | Average | Hot Spot(s)? | Hot Spot |
|---|---|---|---|---|
| Orientation | Sample Type | (cd/m2) | (Yes/No) | (cd/m2) |
| 0 | Spectralon | 119 | No | — |
| 0 | Concave Structures | 18 | No | — |
| 0 | Beehives | 129 | Yes | 2253 |
| 0 | Hemispheres | 108 | Yes | 2317 |
| 0 | Quarterspheres | 77 | Yes | 3098 |
| 90 | Spectralon | 119 | No | — |
| 22.5 | Concave | 180 | Yes | 2816 |
| | Structures | | | |
| 22.5 | Beehives | 138 | Yes | 3158 |
| 22.5 | Hemispheres | 124 | Yes | 2499 |
| 22.5 | Quartersphere s | 164 | Yes | 3328 |

TABLE 4
Average and Hot Spot Luminance of
Physical Samples in Configuration 2

| | | | Hot | |
|---|---|---|---|---|
| Sample | | Average | Spot(s)? | Hot Spot |
| Orientation | Sample Type | (cd/m2) | (Yes/No) | (cd/m2) |
| 0 | Spectralon | 54 | No | — |
| 0 | Concave Structures | ~0 | Yes | 5 |
| 0 | Beehives | ~0 | Yes | 5 |
| 0 | Hemispheres | 75 | Yes | 1809 |
| 0 | Quarterspheres | 65 | Yes | 1500 |
| 90 | Spectralon | 54 | No | — |
| 22.5 | Concave Structures | ~0 | Yes | 5 |
| 22.5 | Beehives | ~0 | Yes | 5 |
| 22.5 | Hemispheres | 55 | Yes | 1808 |
| 22.5 | Quartersphere s | 65 | Yes | 1300 |

TABLE 5
Average and Hot Spot Luminance of
Physical Samples in Configuration 3

| Sample | | Average | Hot Spot(s)? | Hot Spot |
|---|---|---|---|---|
| Orientation | Sample Type | (cd/m2) | (Yes/No) | (cd/m2) |
| 0 | Spectralon | 119 | No | — |
| 0 | Concave Structures | 35 | Yes | 1154 |
| 0 | Beehives | 60 | Yes | 1850 |
| 0 | Hemispheres | 34 | Yes | 1128 |
| 0 | Quarterspheres | 20 | Yes | 487 |
| 90 | Spectralon | 119 | No | — |
| 22.5 | Concave Structures | 54 | Yes | 1913 |
| 22.5 | Beehives | 51 | Yes | 1831 |
| 22.5 | Hemispheres | 14 | Yes | 802 |

TABLE 6
Average and Hot Spot Luminance of
Physical Samples in Configuration 4

| Sample | | Average | Hot Spot(s)? | Hot Spot |
|---|---|---|---|---|
| Orientation | Sample Type | (cd/m2) | (Yes/No) | (cd/m2) |
| 0 | Spectralon | 119 | No | — |
| 0 | Concave Structures | 7 | Yes | 65 |
| 0 | Beehives | 6 | No | — |
| 0 | Hemispheres | 8 | No | — |
| 0 | Quarterspheres | 5 | No | — |
| 90 | Spectralon | 119 | No | — |
| 22.5 | Concave Structures | 27 | Yes | 612 |
| 22.5 | Beehives | 63 | Yes | 1349 |
| 22.5 | Hemispheres | 34 | Yes | 582 |
| 22.5 | Quartersphere s | 7 | Yes | 12 |

### Comparative Example 1. Results—Spectralon

Configuration 1 exhibits the highest light return, which is expected because the light source is closest to the Spectralon sample in this configuration. Essentially all light that is reaching the ProMetric in this configuration is diffusely scattered. Configurations 2, 3, and 4 all have the light the same distance from the sample. Configuration 2 has the next highest light return, presumably due to the combination of a small specular contribution to light return, in addition to the contribution due to diffuse reflectance. The Spectralon is 99% diffuse reflecting, not 100%. The light returns from configurations 3 and 4 are very similar and are less than that from configuration 2. For configurations 3 and 4, the predominant contribution to light return is diffuse reflectance. Rotating the sample 90 degrees did not produce substantially different results, supporting the assumption that the Spectralon is generally isotropic.

### Example 1. Results—Hemispheres and quarterspheres

With the array at a 0 degree orientation, the hot spots were observed for configurations 1-3, but not for configuration 4. With the array at a 22 degree orientation, hot spots were observed for all four configurations. This difference illustrated the effect of shadowing from adjacent structures that was mitigated by turning the sample relative to the ProMetric-sample plane.

The effect of adjacent structures is also apparent when comparing the values for configurations 1 and 2 for both array orientations and comparing configurations 3 and 4. For configurations 1 and 2, shadowing or multi-reflection effects do not appear to play a significant role because the luminance values are very similar for both array orientations.

For configurations 3 and 4, the luminance values for configuration 3 are lower than configuration 4 for the 22.5 degree orientation, and higher than configuration 4 for the 0 degree orientation. This suggests that shadowing or multi-reflection effects are impacting these results. Configuration 1 exhibited the highest luminance as for the Spectralon samples, again in part because the light source was closest to the reflector surface. For the same a, the luminance decreased as the f_{source} increased from 0 to 180 degrees.

The luminance for configuration 1 was substantially higher for the quartersphere arrays than for the hemisphere arrays. For other configurations, the values were lower for the quartersphere arrays than for the hemisphere arrays. The quartersphere arrays showed the same trend for configurations 2-4 as the hemisphere array in that for the same α, the luminance decreased as the f_{source} increased from 0 to 180 degrees.

### Example 1. Results—Square-packed array of Beehives

With the array at a 0 degree orientation, bright hot spots were observed for configurations 1 and 3, extremely dim hot spots were observed for configuration 2, and no hot spots were observed for configuration 4. With the array at a 22 degree orientation, the brightest hotspots were observed for configuration 1, bright hot spots were observed for configurations 3 and 4, and extremely dim hot spots were observed for configuration 2.

For configurations 1 and 4, the differences between the results in the 22 and 0 degree orientations illustrate effects of shadowing and multi-reflection effects associated with the pattern for the given Beehive Structures geometry. The shadowing is particularly extreme for configuration 4, where the peaks of the beehives block reflection from adjacent Beehives when the sample is in the 0 degree orientation. By comparison, configuration 3 is independent of sample geometry for 0 and 22 degree orientations, as there is a strong divergent reflection.

In configuration 2, the geometry of the top of the feature led to substantial shadowing. In this configuration, incident light was largely reflected with at least some vector component in the direction of the light source and Beehives effectively shadowed the side opposite the light source. The divergent reflection resulted in very little light being reflected toward the camera, resulting in very dim hot spots. Unlike sphere structures, the Beehive did not have an area at the top of the feature with comparatively large radius that permitted a substantial amount of light to divergently bounce toward the Prometric camera when the light source was opposite the camera. In configuration 1, the hotspots were 20-30 times brighter than the Spectralon control, and in configurations 3 and 4, they were 10-15 times in configurations where shadowing was not diminishing the return (e.g. 22 degree sample orientation with configuration 4). This enables a reflective structure that can be selectively illuminated and visible from some orientations but not from others.

### Example 1. Results—Square-packed array of Concave Structures

With the array at a 0 degree orientation, strong hot spots were observed for configuration 3, weak or extremely weak hot spots were observed for configurations 2 and 4, and no hotspots were observed for configuration 1. With the array at a 22 degree orientation, strong hot spots were observed for conditions 1, 3 and 4, but only extremely weak hot spots were observed for configuration 2. The differences between the results in the 22 and 0 degree orientations illustrate effects of shadowing and multi-reflection effects associated with the pattern for the given Concave Structures geometry. The reflective area of the Concave Structures was small and highly divergent, resulting in extremely dim hotspots and average luminance values when the light source is opposite the observer.

When shadowing from adjacent features was mitigated in the 22 degree orientation, the luminance of each hotspot observed in configurations 1 and 3 was more than an order of magnitude larger than the luminance of the Spectralon panel. The average value of luminance from the reflector array was also higher than the Spectralon panel for case 1 where the light source was directly overhead.

In configurations 1, 3 and 4, the hotspots were 5 to more than 20 times brighter than the Spectralon control in a sample orientation where shadowing was not diminishing the return (e.g. 22 degree sample orientation). In configuration 2, hotspots were not brighter than the Spectralon at either sample orientation. This enables a reflective structure that can be selectively illuminated and visible from some orientations but not from others.

### Example 2. SPEOS simulation of arrays of Concave Structures and Hemispheres

Virtual photometric analysis of the square-packed array of the 7 mm Concave Structures and square-packed array of Hemispheres were conducted with SPEOS. Sample orientation aligns with the orientation of the square-packed arrays, a 0 degree orientation aligns with the axis created along the rows or columns of the square-packed array. Simulated samples contain one type of sample type, either concave structure or hemispheres.

Software Geometries of arrays of Concave Structures and Hemispheres were constructed in Solidworks (Dassault Systémes Americas Corp., Waltham, MA) and imported into ANSYS SPEOS (ANSYS, Inc., Canonsburg, PA) for virtual photometric analysis.

### Simulations

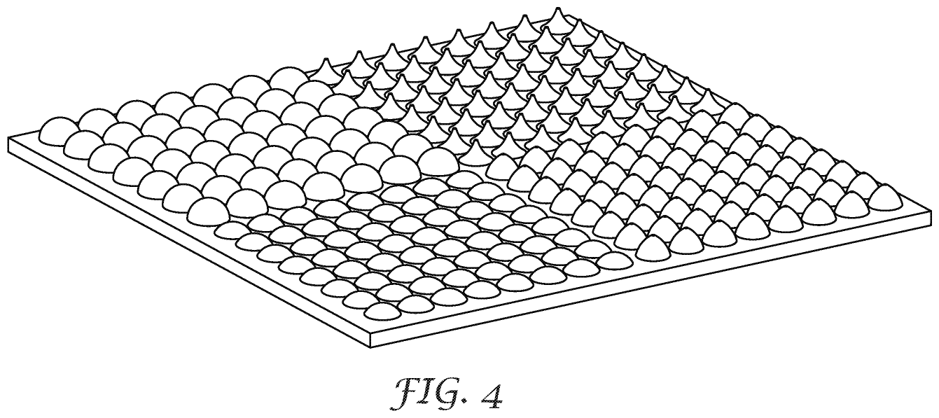

A drawing of the Solidworks arrays is illustrated in FIG. 4. Four geometries are represented: hemispheres, quarterspheres, Concave Structures, and beehives. The concave and cone quadrant was used for empirical examples, and this geometry was imported into SPEOS for ray tracing simulations.

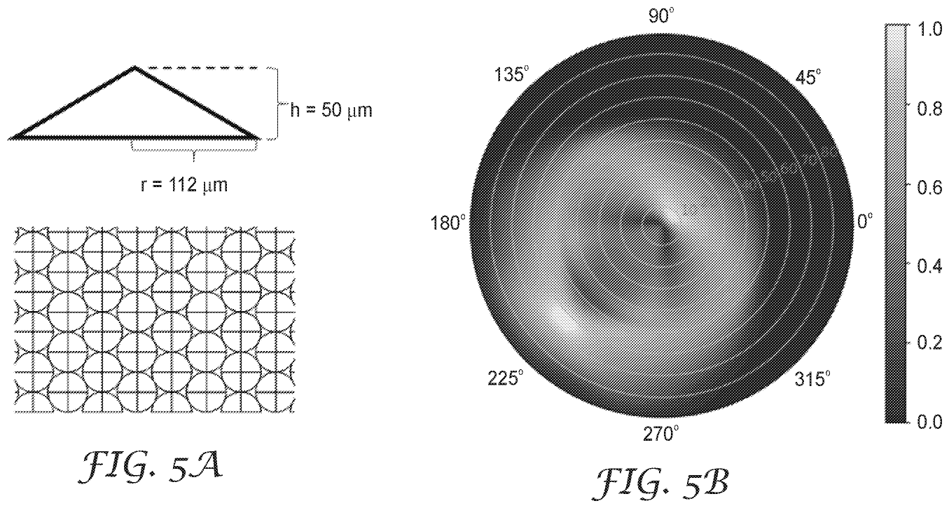

To simulate square-packed arrays of Concave Structures and hemispheres, the CAD (computer aided design) model in SPEOS used to simulate the SolidWorks array illustrated in FIG. 5 was built. A 50-50 specular-Lambertian material was applied on the first surface mirror. The interstitial regions were 100% Lambertian. The light source was a circular surface with 100 mm in diameter and with 100 cd luminous intensity. The source intensity distribution was Lambertian with 1800 total beam angle. To estimate luminance as detected by a photometric camera, a luminance sensor was placed in the model at a 10° elevation angle.

TABLE 7
Sample Square-packed Array of Concave
Structures - SPEOS simulation Results

| Sample | Illumination | | Max Luminance |
|---|---|---|---|
| Orientation | Incident Angle | Azimuthal Angle | (cd/m2) |
| 0 | 0 | 0 | 73 |
| 0 | 40 | 0 | 42 |
| 0 | 40 | 30 | 151 |
| 0 | 40 | 60 | 5313 |
| 0 | 40 | 90 | 4027 |
| 0 | 40 | 120 | 105 |
| 0 | 40 | 150 | 111 |
| 0 | 40 | 180 | 101 |
| 22.5 | 0 | 0 | 6821 |
| 22.5 | 40 | 0 | 31 |
| 22.5 | 40 | 30 | 3948 |
| 22.5 | 40 | 60 | 3721 |
| 22.5 | 40 | 90 | 4833 |
| 22.5 | 40 | 120 | 3410 |
| 22.5 | 40 | 150 | 3804 |
| 22.5 | 40 | 180 | 3724 |

TABLE 8
Sample Square-packed Array of Hemispheres
- SPEOS simulation Results

| | Illumination | | |
|---|---|---|---|
| Sample | Incident Angle | Azimuthal Angle | Max Luminance |
| Orientation | (degree) | (degree) | (cd/m2) |
| 0 | 0 | 0 | 6591 |
| 0 | 40 | 0 | 1476 |
| 0 | 40 | 30 | 1864 |
| 0 | 40 | 60 | 2005 |
| 0 | 40 | 90 | 1113 |
| 0 | 40 | 120 | 63 |
| 0 | 40 | 150 | 109 |
| 0 | 40 | 180 | 103 |
| 22.5 | 0 | 0 | 3264 |
| 22.5 | 40 | 0 | 1596 |
| 22.5 | 40 | 30 | 1836 |
| 22.5 | 40 | 60 | 2096 |
| 22.5 | 40 | 90 | 2133 |
| 22.5 | 40 | 120 | 2205 |
| 22.5 | 40 | 150 | 2452 |
| 22.5 | 40 | 180 | 2132 |

TABLE 9
Sample Spectralon - SPEOS simulation Results

| | Illumination | | |
|---|---|---|---|
| Sample | Incident Angle | Azimuthal Angle | Max Luminance |
| Orientation | (degree) | (degree) | (cd/m2) |
| Spectralon | 0 | 0 | 40 |
| Spectralon | 40 | 0 | 21 |
| Spectralon | 40 | 30 | 21 |
| Spectralon | 40 | 60 | 18 |
| Spectralon | 40 | 90 | 16 |
| Spectralon | 40 | 120 | 15 |
| Spectralon | 40 | 150 | 15 |
| Spectralon | 40 | 180 | 15 |

For the concave structure array with 0° sample rotation, the hot-spot “coverage area” is substantially smaller compared to when the sample is rotated by 22.5°. This is consistent with the shadowing effect observed in empirical testing discussed in Example 1.

For the concave structure, when the azimuthal angle is 0° (Configuration 2), no hot spots are visible for both non-rotated and rotated samples, consistent with Example 1. For the non-rotated concave structure array, strong hots spots are visible only for a narrow range of source azimuthal angles—between 60′ and 90°. This is consistent with the Configuration 3 result for 0° sample rotation in Example 1.

For the concave structure array rotated to 22.5°, the maximum luminance of hot spots is relatively constant with changing source azimuthal angles. Like the empirical sample in Example 1, the only combination of incident and azimuthal angle of the source considered that did not have a substantial hotspot return is that where the azimuthal angle was 0° (Configuration 2). For hemisphere arrays with 0° rotation and source azimuthal angles less than 90°, the hot spots are visible.

The maximum luminance values of these hot spots are two orders of magnitude higher than that of the Spectralon sample, with values for an incident angle of 0° higher than for an incident angle of 40°, as observed empirically in Example 1. When the azimuthal position of the source is greater than 90°, no hot spots are visible, and maximum luminance is comparable to that of the Spectralon sample.

For the hemisphere arrays with 22.5° rotation, the maximum luminance of hot spots is relatively constant with all source azimuthal angles, with slightly higher luminance for an incident angle of 0° than for an incident angle of 40°. The maximum luminance values of these hot spots are two orders of magnitude higher than that of the Spectralon sample.

For both simulated sample orientations, the maximum luminance of the hot spot is two orders of magnitude higher than that of the Spectralon sample. This is higher than realized with the empirical sample, but differences may result from non-Lambertian character of the lamp used in Example 1 and imperfections in the reflective surface associated with the 3D printing and metallization process.

### Example 3—Simulated Polar Plots of Sample Types in Close-packed Hexagonal Arrays

Geometries of arrays of cones were constructed in LightTools (SYNOPSYS, Mountain View, CA), and ray tracing simulations were performed in this same software.

LightTools simulation was employed to illuminate a quadrant of a cone array with geometry and packing density illustrated in FIG. 5a, and to integrate the cumulative light return over all observer azimuthal angles for observer elevation angles (0) less than less than 17.5°. Illumination of the quadrant produces light return from source incident angles of 0-40° for all possible array orientations relative to the light source, or by corollary, all possible source azimuthal orientations relative to the array. This light return is integrated over a far field detector to map all of the observer elevation angles and azimuthal angles for which there is a measurable return from any portion of the illuminated quadrant, and thereby from any sample orientation and position relative to the source. FIG. 5b is a polar plot that illustrates the projected area map of the far-field hemispherical reflected light return. Each circle on the polar plot represents 10 degrees of observer elevation angle (e.g. the exact center of the plot is light that is reflected along the normal to the planar surface supporting the reflective array.) The numbers around the outside represent all azimuthal angles of the observer around the hemisphere that defines the far-field boundary. In this instance, detectable light return is detected from this array for elevation angles less than less than 17.5° from any sample orientation only for any observer azimuthal angle in the arc of increasing azimuthal angles ranging from ˜150 to ˜290°.

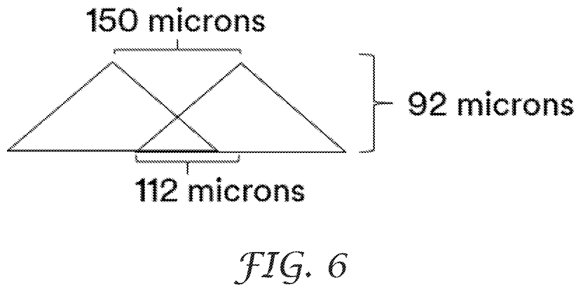

Nonoptimized hexagonal cone array. FIG. 6 shows the cone cross-sectional geometry along with a top view of the hexagonal pattern layout. The center—center cone spacing is 2r such that the edges of the cones are just touching adjacent neighbors without overlapping. Light at observer elevation angles less than 17.5° accounts for 8.42% of the total reflected light.

### Example 4: LightTools Simulation of Light Return from Close-Packed Overlapping Hexagonal Cone Array

LightTools simulation also was used to map light return from a specific source incident and azimuthal position for a fixed array position, providing additional insight to approaches such as those detailed in Examples 1 and 2. The simulation was set up as in Example 3, but light return was not integrated from all regions in the quadrant, but rather only from a specific spot in the quadrant. A close-packed overlapping hexagonal cone array with a center-to-center cone spacing of 150 mm, cone height of 92 mm, and radius of 112 mm was illuminated, as illustrated in FIG. 6.

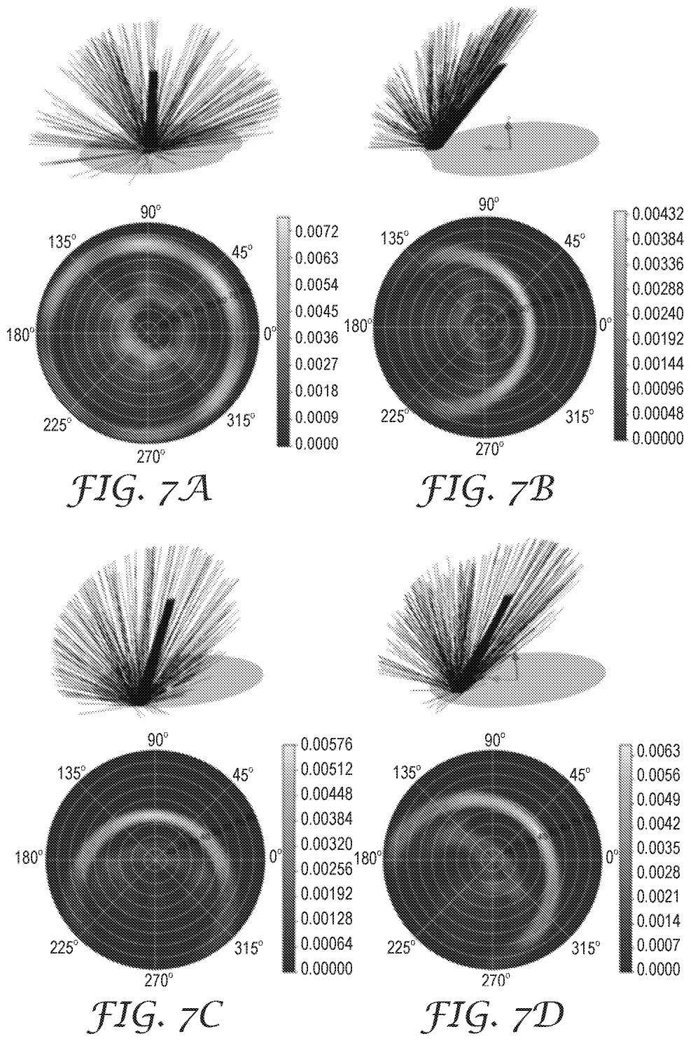

FIGS. 7a-d illustrate the illumination geometry and the polar plots of the reflected light return pattern collected by the far-field observer from illumination of this array from specific source incident and azimuthal angles. In the illumination geometry images, black lines represent rays of light either incident on a substrate at a particular point or reflecting from the substrate. In the middle of all of the distribution of lines, there is a dense dark region because all of the rays of incident light fall in a narrow beam and thus appear to overlap in the schematic. The incident rays in this dense dark region are reflected from the substrate, and can reflect in many directions. These reflected rays are illustrated as a sparser distribution of black lines that begin at the illuminated spot on the substrate.

FIG. 7a illustrates the case where the source incident angle is centered at incident polar angle ˜8° and an azimuth ˜225°. Light reflected from this illuminated spot is observable at all azimuthal angles for observer elevation angles of 17.5° or less. For observer elevation angles of 10° or less, only azimuthal angles from 135-315° observe a light return.

In FIG. 7b, light is incident on a position on the quadrant with an incident angle of ˜40° and a source azimuth of ˜180°. The only visible light return from this illuminated spot for observer elevation angles of 17.5° or less occur at observer azimuths of ˜120° and ˜240°.

In FIG. 7c, light is incident on a position on the quadrant with an incident angle of ˜40° and a source azimuth of ˜270°. The only visible light return from this illuminated spot for observer elevation angles of 17.5° or less occur at observer azimuths of ˜210 and ˜330°.

In FIG. 7d, light is incident on a position on the quadrant with an incident angle of ˜40° and a source azimuth of ˜225°. The only visible light return from this illuminated spot for observer elevation angles of 17.5° or less occur at observer azimuths of ˜165° and ˜300°. FIG. 7 conatins illustrations of incident and reflected rays from specific locations in the illuminated quadrant for an overlapping hexagonal array of cones, and polar plots summarizing reflected light return from each of those illuminated spots.

FIG. 7a models the case where the light source is positioned directly above reflective structure, such as the case where a streetlight is hung above a crosswalk above a lane. The reflective structure immediately beneath the streetlight would be visible to observers at observation angles of 17.5 degrees or less at all azimuthal angles relative to the axis connecting the light source and reflective structure. This range of observation angles represents useful observer maximum detection distances relative to the reflective article as the observer approaches the reflective article from any direction, as in the use cases of a cyclist approaching a marking or a pedestrian viewing a crosswalk or a driver turning from a cross street toward a crosswalk.

FIGS. 7b, 7c and 7d model cases where the light source is not directly over the reflective structure, but rather off to one side of it. Examples include but are not limited to: a street lamp on a curb next to lanes of travel marked with a crosswalk containing reflective structures, ambient light sources (e.g. shop windows) next to reflective structures positioned on or near the ground, and street lamps illuminating a bike lane or path marked with reflective structures. In each of FIGS. 7b, 7c and 7d, the light source is positioned with a 40 degree incident angle relative to the surface normal above the reflective structure.

In the case of FIG. 7b, the reflective structure would be present in a plane orthogonal to the primary direction of travel (e.g. the reflective structure would be mounted in a crosswalk) and the light source would be on the side of the roadway or path on that same orthogonal plane. In that lighting scenario, a reflective structure in this position would result in light return from that illuminated spot that would be visible to observers approaching the crosswalk at 120 and 240 degrees (e.g. cyclists in a lane adjacent to the lane of vehicle travel) when the observer was at a distance corresponding to an observation angle of 17.5 degrees, and where the direction of travel of the roadway or path is defined as from 270 degree toward 90 degrees on this polar plot. For observers viewing that illuminated spot on reflective structure from other directions (e.g. from 0 degrees or 180 degrees on this polar plot) and from a distance corresponding to an observation angle of 17.5 degrees, this illuminated spot of the reflective structure would be dark.

For observers at closer distances and observation angles larger than 17.5 degrees, the azimuthal angle at which that illuminated spot on the reflective structure is visible approaches zero degrees as the observer approaches this spot on the reflective structure. At an azimuthal angle of zero degrees, someone walking away from the light source in the crosswalk would see this particular illuminated spot on the reflective structure when they were at a distance from this spot corresponding to observation angles ˜50-60 degrees. For an individual whose eyes were 1.7 m above the ground, that spot on the reflective structure would have a bright light return when that illuminated spot was 1-1.4 m ahead of the pedestrian. Crosswalks can be quite dim at night in locations where the incident light angle is large, especially when the markings are worn. This reflective structure example would improve visibility of that location on the crosswalk for pedestrians walking in that dim location.

In FIG. 7c, the roadway, lane or path, the reflective structure and the direction of travel would all be on the same plane where the direction of travel is defined as from 270 degree toward 90 degrees on this polar plot. Examples of this include a light source hanging over reflective structures on a demarcation of a bike lane or sidewalk. The reflective structure would be positioned closer to a traveler approaching from 270 degrees than the light source. In this lighting scenario, a reflective structure in this position would result in light return from the illuminated spot on the reflective structure that would be visible to observers at 220 and 320 degrees at a distance corresponding to an observation angle of 17.5 degrees (e.g traveling on a path adjacent to the demarcated lane of travel). For observers viewing that illuminated spot on reflective structure from other directions (e.g. from 90 degrees or 270 degrees on this polar plot) and from a distance corresponding to an observation angle of 17.5 degrees, this illuminated spot of the reflective structure would be dark.

For observers at closer distances and observation angles larger than 17.5 degrees, the azimuthal angle at which that illuminated spot on the reflective structure is visible approaches 90 degrees as the observer approaches this spot on the reflective structure. At an azimuthal angle of 90 degrees, someone on the path approaching from opposite the defined direction of travel would see this particular illuminated spot on the reflective structure when they were at a distance from this spot corresponding to an observation angle of 50 degrees.

In FIG. 7d, the reflective structure is positioned on the plane that bisects the angle defined by the intersection of a first and second plane, where the first plane contains the direction of travel and the surface normal from the roadway or path to the light source and where the second plane is orthogonal to the first plane and contains the surface normal from the roadway or path to the light source. Again, the direction of travel is defined as from 270 degree toward 90 degrees on this polar plot. In this instance, the streetlamp might be on a curb, and the reflective structure would be positioned closer to a traveler approaching from 270 degrees than the light source but perhaps along a line of skips on the side of the ego lane opposite the street lamp. In this lighting scenario, a reflective structure in this position would result in light return from the illuminated spot on the reflective structure that would be visible to observers at 180 and 280 degrees at a distance corresponding to an observation angle of 17.5 degrees. This could make this location marking visible for drivers following the defined path of travel, and for drivers turning right from a cross-street toward the reflective structure. For observers viewing that illuminated spot on reflective structure from other directions (e.g. from 45 degrees or 225 degrees on this polar plot) and from a distance corresponding to an observation angle of 17.5 degrees, this illuminated spot of the reflective structure would be dark. For observers at closer distances and observation angles larger than 17.5 degrees, the azimuthal angle at which that illuminated spot on the reflective structure is visible approaches 45 degrees as the observer approaches this spot on the reflective structure. At an azimuthal angle of 45 degrees, someone jaywalking from the street lamp back toward the reflective structure or on a scooter cutting a corner and driving toward the reflective structure would see this particular illuminated spot on the reflective structure when they were at a distance from this spot corresponding to an observation angle of 50 degrees.

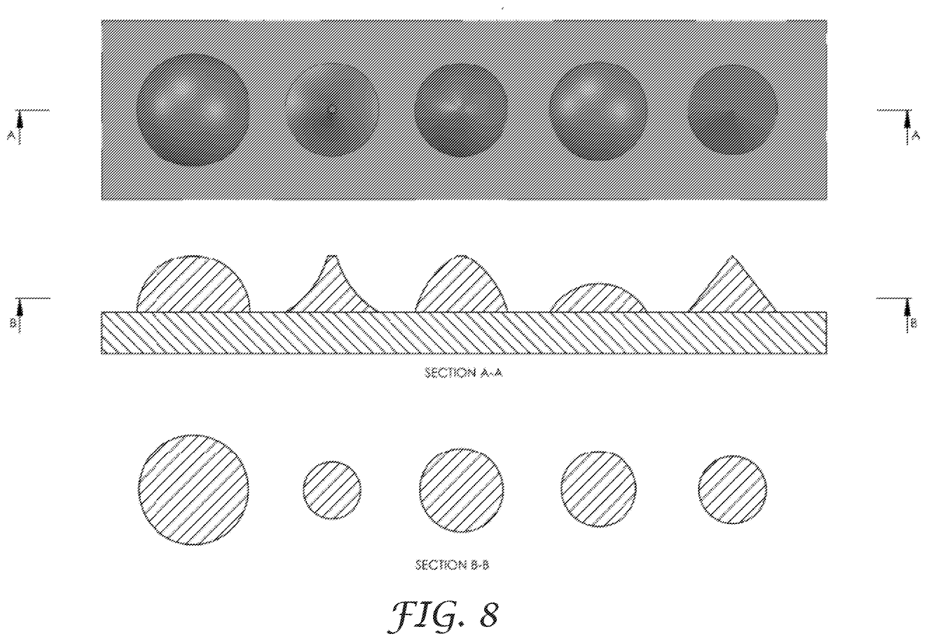

### FIG. 8

FIG. 8 shows atop view of different structures/elements, left to right, hemisphere, concave structure, beehive, quartersphere, and cone structure and two cross section views, section A-A and section B-B. Section A-A shows the profile of the structures when the section plane is orthogonal to aground plane. Section B-B shows the convex profile of the structure when the section plane is parallel to the ground plane.

1. A reflective article comprising:
a substrate having a structured surface that extends along a reference plane, wherein the structured surface comprises at least one opaque structure,
wherein the at least one structure comprises:
a reflective surface configured to reflect radiation rays,
wherein the reflected rays comprise either diverging rays or converging rays, wherein at least part of the reflective surface is radially symmetric around an axis that is normal to the reference plane, and
wherein the reflective surface is the outer surface of the structure.

2. A reflective article comprising:
a substrate having a structured surface that extends along a reference plane, wherein the structured surface comprises at least one opaque structure,
wherein the at least one structure comprises:
a reflective surface configured to reflect radiation rays,
wherein the reflected rays comprise either diverging rays or converging rays,
wherein at least part of the reflective surface is radially symmetric around an axis that is normal to the reference plane,
wherein the reflective surface is the outer surface of the structure,
wherein at least part of the radially symmetric reflective surface is convex along the curve formed by the intersection of a plane orthogonal to the reference plane and the portion of the surface that is radially symmetric.

3. A reflective article comprising:
a substrate having a structured surface that extends along a reference plane, wherein the structured surface comprises at least one opaque structure,
wherein the at least one structure comprises:
a reflective surface configured to reflect radiation rays,
wherein the reflected rays are diverging or converging,
wherein at least part of the reflective surface is radially symmetric around an axis that is normal to the reference plane,
wherein the structure is opaque,
wherein the reflective surface is the outer surface of the structure,
wherein at least part of the radially symmetric reflective surface is concave along the curve formed by the intersection of a plane orthogonal to the reference plane and the portion of the surface that is radially symmetric.

4. A reflective article according to claim 1, wherein the structured surface comprises a plurality of opaque structures arranged in a repeating pattern, wherein the pattern is a hexagon having a structure with its axis of symmetry located on each vertex of the hexagon and at the centroid of the hexagon.

5. A reflective article according to claim 1, wherein the reflective surface reflects from 75% to 100% of the incident rays in a specular manner in one or more of the following ranges: near infrared, visible, and ultraviolet spectra.

6. A reflective article according to claim 1, wherein the substrate comprises one or more polymers chosen from acrylic polymers, polycarbonate polymers, and polyurethane polymers.

7. A reflective article according to claim 1, wherein the reflective surface comprises one or more materials chosen from aluminum, silver, dichroic film, and combinations thereof.

8. A reflective article according to claim 1, wherein the reflective surface is a layer immediately adjacent to the substrate forming the structure.

9. A reflective article according to claim 1, wherein the substrate comprises microreplicated structures.

10. A reflective article according to claim 1, wherein each structure has a height and a radius,
wherein the height is defined by the distance from the reference plane to the point where the axis of symmetry intersects the radially symmetric surface, and
wherein the radius is defined by the average distance from an origin to the line formed by the intersection of the reference plane with the portion of the structure that is radially symmetric,
wherein the origin is at the intersection of the axis of symmetry and the reference plane, wherein the height ranges from 100 microns to 200 microns.

11. A reflective article according to claim 1, wherein in at least one structure the reflective surface extends from 10% to 80% of the entire surface of the structure.

12. A reflective article according to claim 1, wherein at least one structure further comprises a clear layer

13. A reflective article according to claim 1, wherein at least one structure further comprises a clear layer, and wherein the clear layer comprises one of more of crosslinked acrylic, crosslinked urethane acrylic, fluoropolymer, fluoro-acrylate, and silicone polymers.

14. A reflective article according to claim 1, wherein the article further comprises an adhesive layer.

15. A system comprising a reflective article according to claim 1, and a light source.
